(19) United States
(12) Patent Application Publication
(10) Pub. No.: US 2005/0072251 A1
(43) Pub. Date: Apr. 7, 2005

(54) Mini core in drilling samples for high resolution Formation Evaluation on drilling cuttings samples.

(76) Inventor: Konstandinos Zamfes, Calgary (CA)

Correspondence Address: KONSTANDINOS ZAMFES, 1830 - 10TH AVE S.W., CALGARY, AB, T3C-OJ8, CA

(21) Appl. No.: 10/711,467

(22) Filed: Sep. 20, 2004

Related U.S. Application Data
(60) Provisional application No. 60/481,447, filed on Sep. 30, 2003.

(51) Int. Cl. G01N 1/14

(52) U.S. Cl. 73/864.62

(57) ABSTRACT

We disclose an apparatus and process for mini core in drilling samples accumulated in the cups by sample catcher. It allows the explorations to obtain high resolution Formation Evaluation on drilling cuttings samples. The process is assuming implementation of samples collected by Sample Catcher as the one described by author in patent U.S. Pat. No. 6,386,026 B1 May 14, 2002. The Mini Core apparatus consists of narrow cylinder with a piston. The thin wall cylinder is rotating by hand and pressed in to the cup with wet sample of drilling cuttings. The piston is placed after the desired depth of sample is reached and the vacuum is re-established. The core is pulled out from the cup and then squeezed out on the flat tray for horizontal analysis. The micro layering can be visually separated, before they are mixed as in conventional sample and the information is lost.

### DETAILED DESCRIPTION

1. Apparatus consists of narrow cylinder with a piston.

2. The process consists of:

2.1. The thin wall cylinder is rotating by hand and pressed in to the cup with wet sample of drilling cuttings.

2.2. The piston is placed after the desired depth of sample is reached and the vacuum is re-established by closing the air hole.

2.3. The core is pulled out from the cup and then squeezed out on the flat tray for horizontal analysis. The micro layering can be visually separated before they are disturbed or mixed and the information is lost.

### CROSS REFERENCE TO RELATED APPLICATIONS

References Cited: U.S. Pat. No. 6,386,026 B1 Kosta Zamfes May 14,2002.

### BACKGROUND OF INVENTION

During the drilling of the well, mud is circulating down hole and brings up the formation cuttings of the strata penetrated at this time. After the lag time, which comprises of the annular velocity and the depth of the well, the cuttings arrive to the surface. At the surface the Sample Catcher device described in U.S. Pat. No. 6,386,026 B1 May 14, 2002, is capturing the material. The apparatus and process disclosed in this invention are extracting the mini core from the cup where the sample catcher accumulates the drilling cuttings samples. By analyzing the strata in sequentially stored cuttings the high resolution Formation Evaluation on drilling cuttings samples is achieved. This leave the remaining material practically undisturbed and good for next core probe if necessary.

### FIELD OF INVENTION

The invention relates to the apparatus and the process for obtaining the Formation mini core in drilling samples for high resolution Formation Evaluation on drilling cuttings samples. This reflecting the physical and petrophysical properties of the formation drilled for Oil and Gas or other targets. The measurements are obtained at the surface and in real time. The process and apparatus of this invention are producing the information while drilling. The mudflow brings the cuttings to the surface. The sample catcher is accumulating the sample in the cups. The mini core extracts the long probe for further subdivision and analysis by depth.

### SUMMARY OF INVENTION

We disclose an apparatus and process for mini core in drilling samples accumulated in the cups by sample catcher. It allows the explorations to obtain high resolution Formation Evaluation on drilling cuttings samples. The process is assuming implementation of samples collected by Sample Catcher as the one described by author in U.S. Pat. No. 6,386,026 B1 May 14, 2002. The Mini Core apparatus consists of narrow cylinder with a piston. The thin wall cylinder is rotating by hand and pressed in to the cup with wet sample of drilling cuttings. The piston is placed after the desired depth of sample is reached and the vacuum is re-established. The core is pulled out from the cup and then squeezed out on the flat tray for horizontal analysis. The micro layering can be visually separated, before they are mixed as in conventional sample and the information is lost.

### BRIEF DESCRIPTION OF DRAWINGS

FIG. 1. is a schematic of Mini core device with sample cup for extracting the high resolution information of drilled formation.

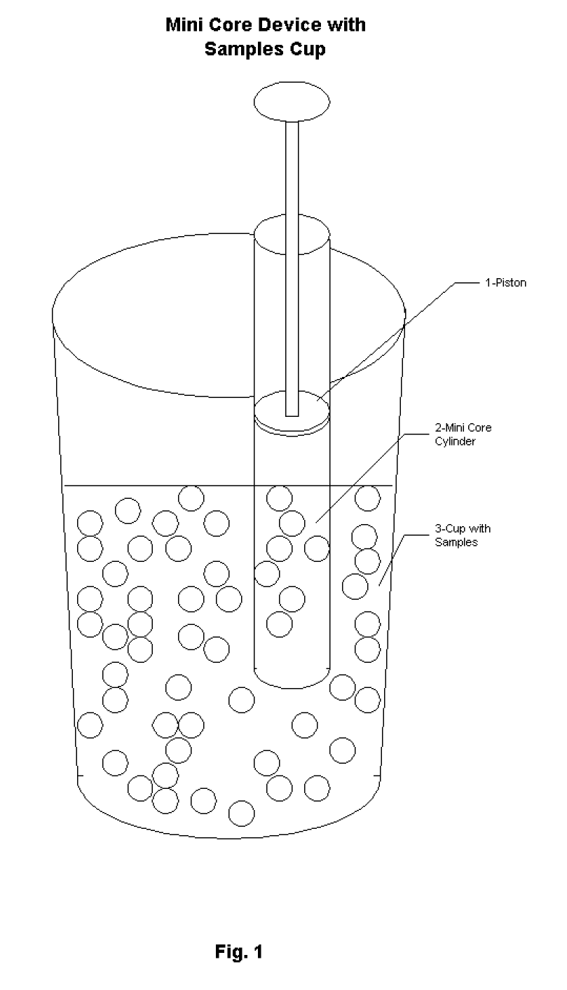

FIG. 2. is the schematic of the Mini core device.

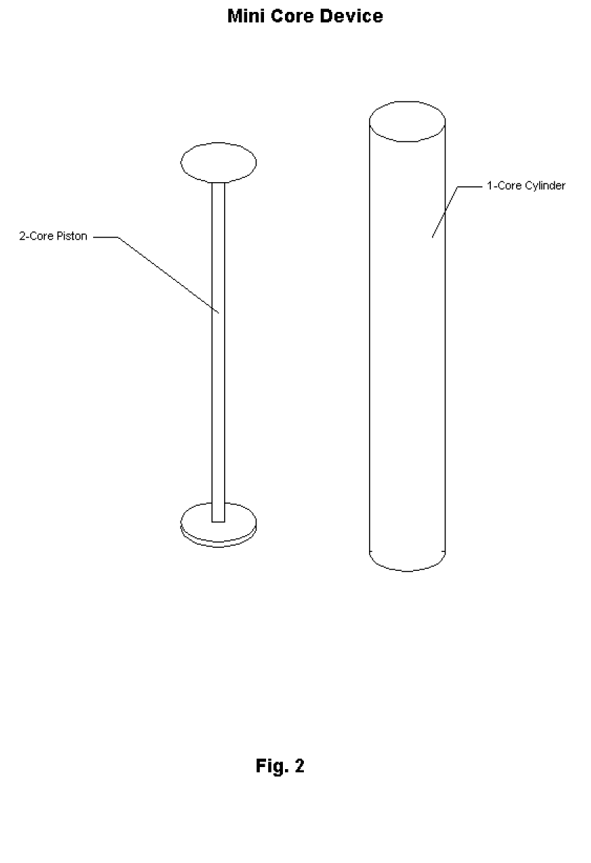

1. is the apparatus consisting of narrow cylinder with a piston.

2. Cancelled.

3. 1.2 is the piston that is placed after the desired depth of sample is reached.

4. 2. The rotating of the thin wall cylinder by hand and pressing it in to the cup with wet sample of drilling cuttings

5. Cancelled.

6. Cancelled.
